(19) United States
(12) Patent Application Publication
(10) Pub. No.: US 2007/0022556 A1
(43) Pub. Date: Feb. 1, 2007

(54) Wind deflector with symmetrical geometry

(76) Inventors: Van T. Walworth, Lebanon, TN (US); David B. Hook, Franklin, TN (US); Craig Whitaker, Fairfield, OH (US); Mark Howell, Lebanon, TN (US); William McGinn, Paragould, AR (US); Joseph C. Bacarella, LaSalle, MI (US)

Correspondence Address: HARNESS, DICKEY & PIERCE, P.L.C., P.O. BOX 828, BLOOMFIELD HILLS, MI, 48303, US

(21) Appl. No.: 11/494,273

(22) Filed: Jul. 27, 2006

Related U.S. Application Data
(60) Provisional application No. 60/703,283, filed on Jul. 28, 2005.

(51) Int. Cl. B60S 1/38; B60S 1/32

(52) U.S. Cl. 15/250.201; 15/250.361; 15/250.48; 15/250.43

(57) ABSTRACT

A resilient windshield wiper assembly is disclosed which comprises a resilient wind-deflector portion molded or extruded to provide a receiving hollow for insertion of a support beam. The resilient wind-deflector portion has a feature strategically positioned and structurally effective to prevent the resilient portion from being rotated or twisted around the support beam. The wind deflector is symmetrical with respect to the axial orientation of the support beam. The symmetry allows conversion of the wind force components from lifting forces to normal forces acting to press and/or hold the wiper against the wiper surface even when subjected to side gusts or reverse head-wind forces. The symmetry further provides a strength member acting directly over the top of the wiping lip surface avoiding introducing a twisting force into the support beam.

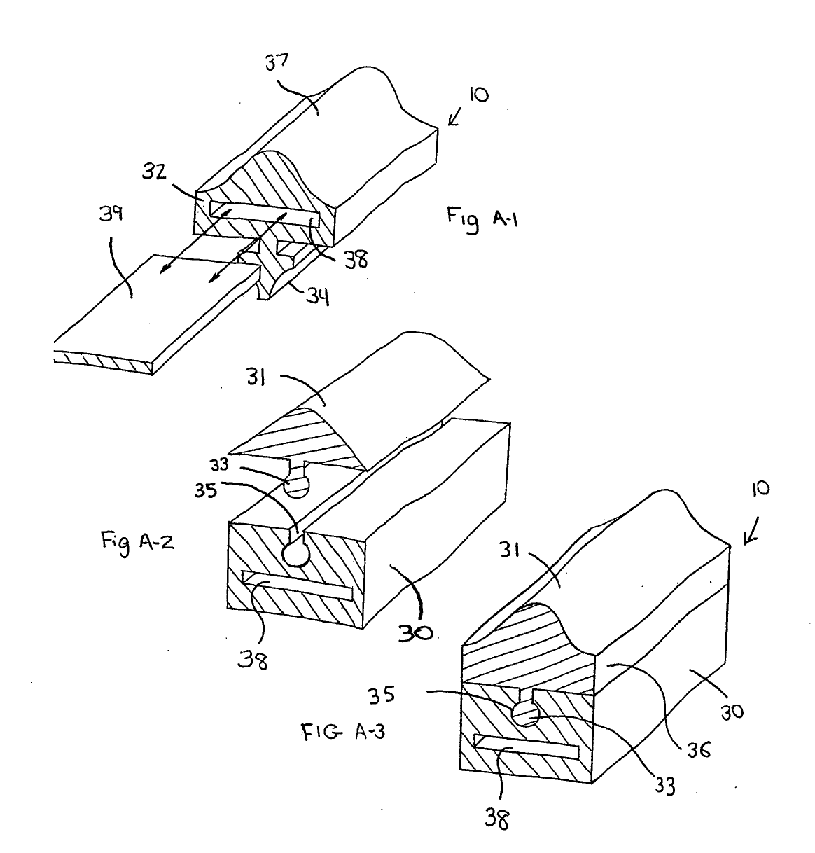

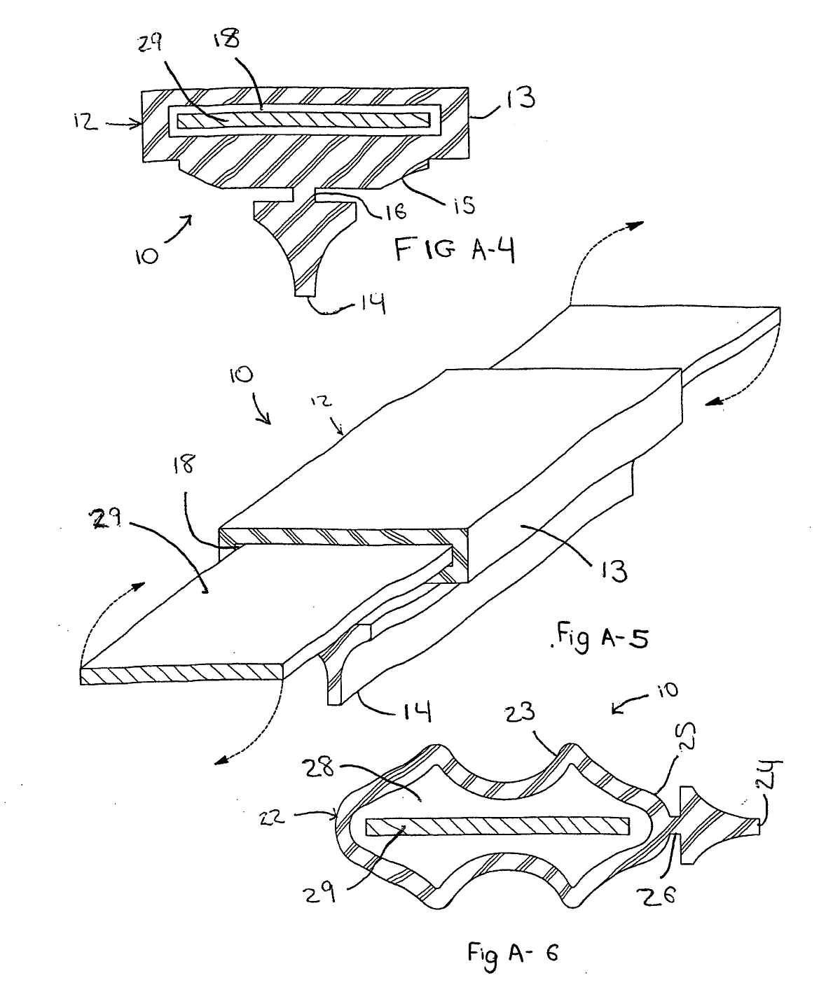

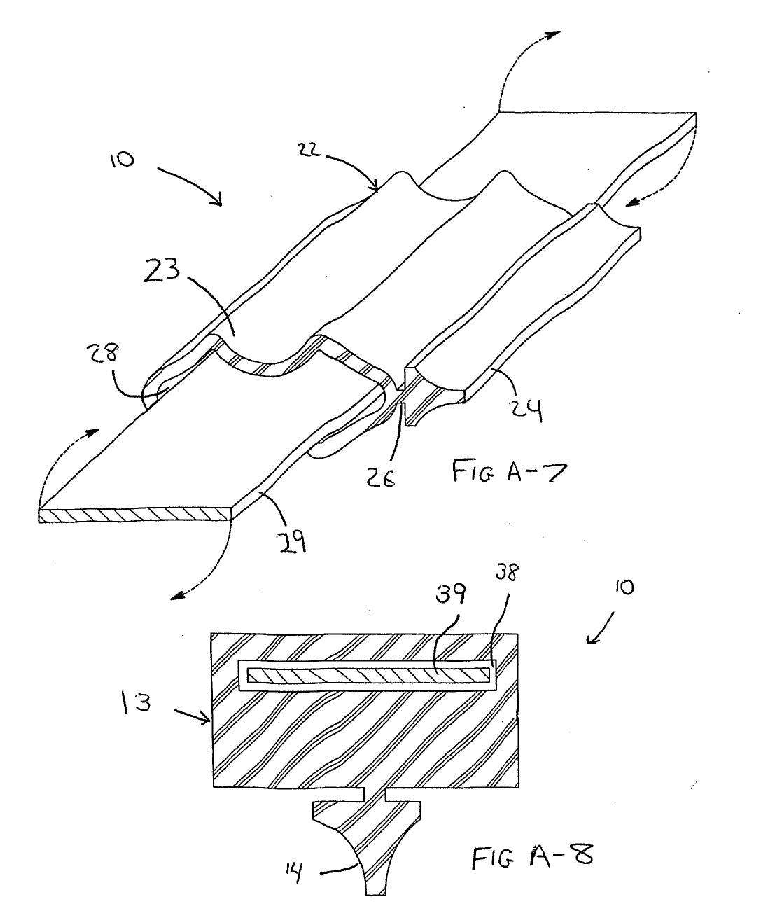

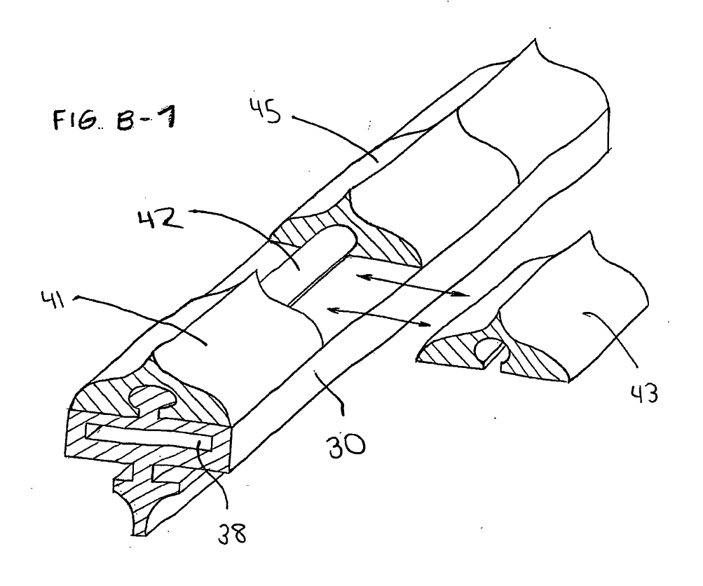

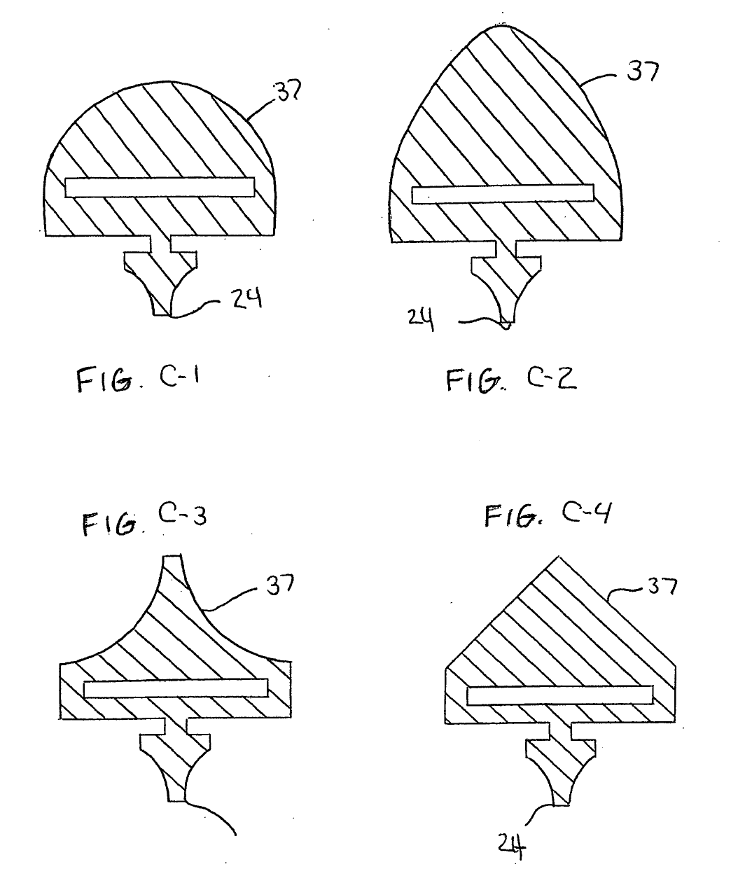

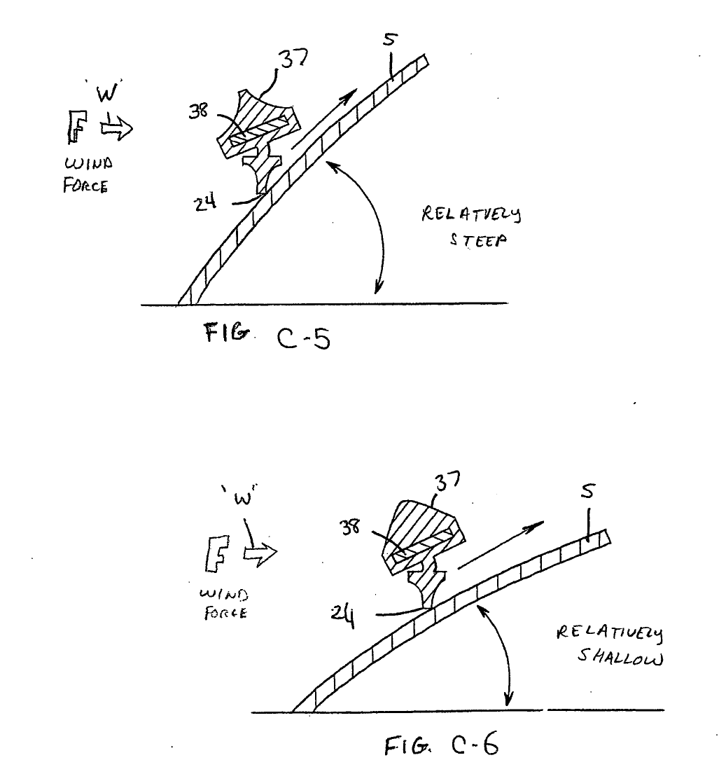

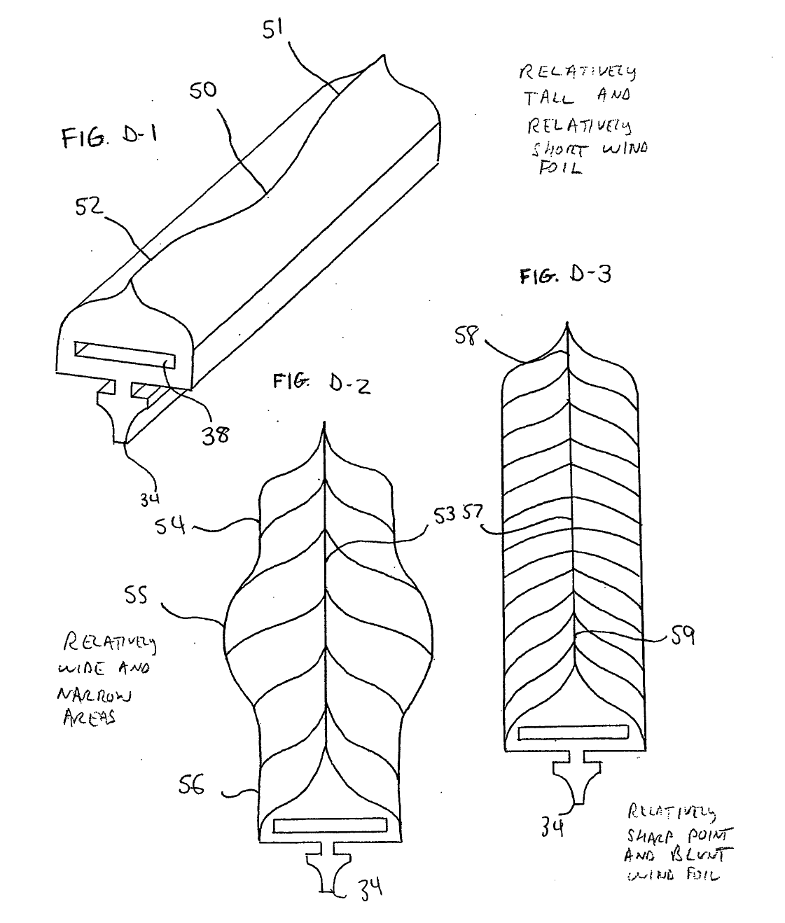

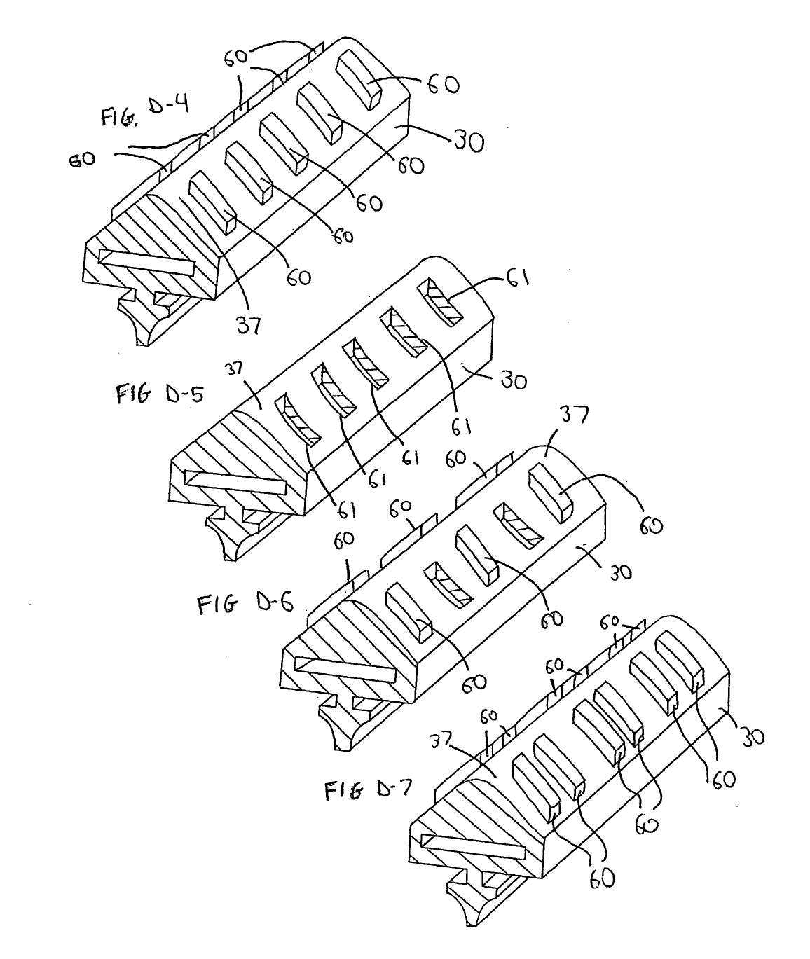

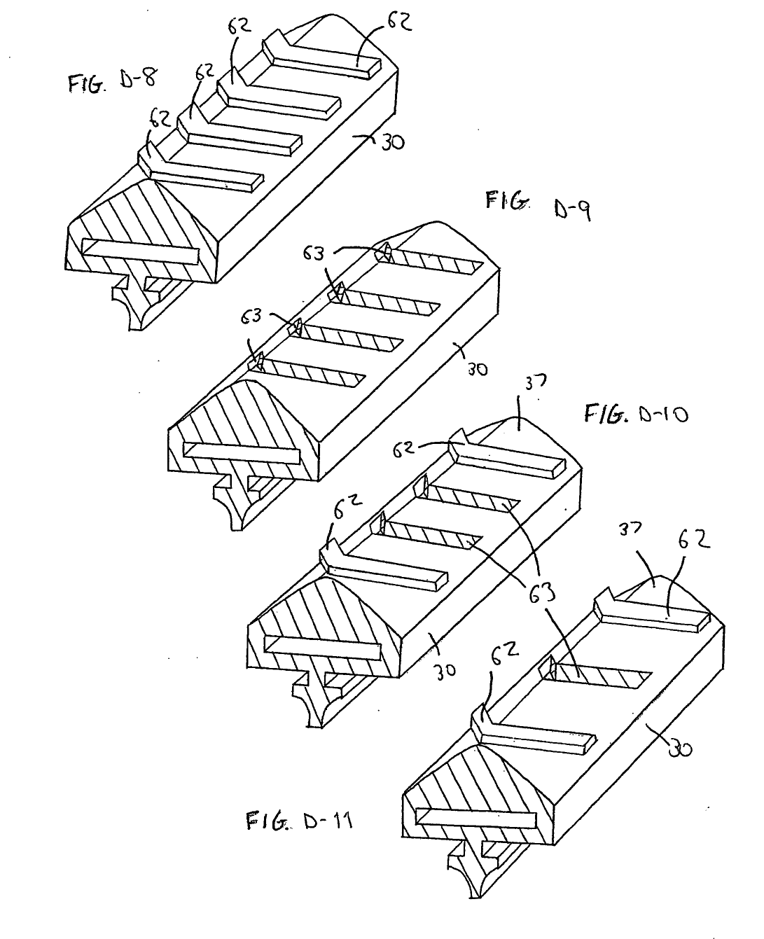

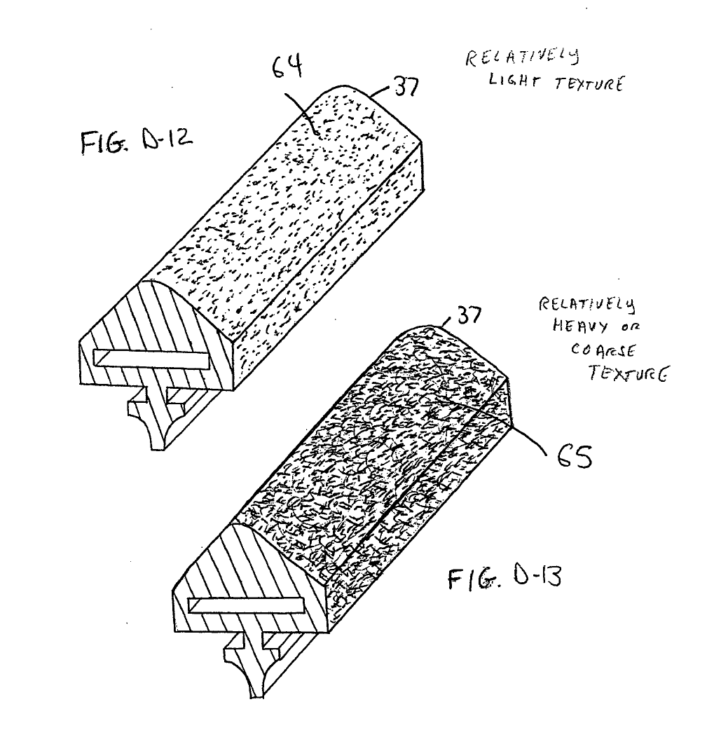

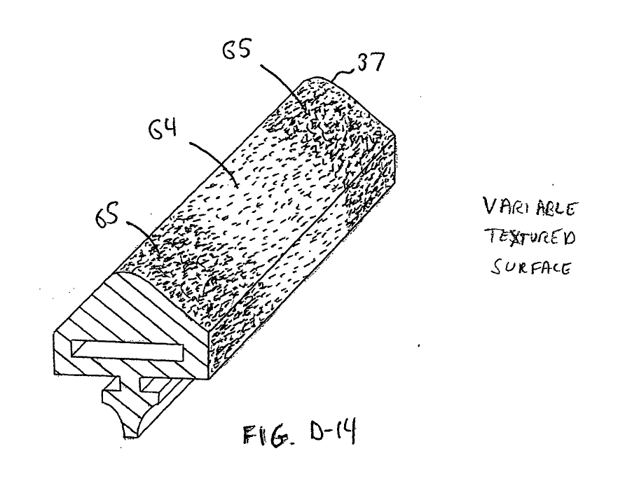

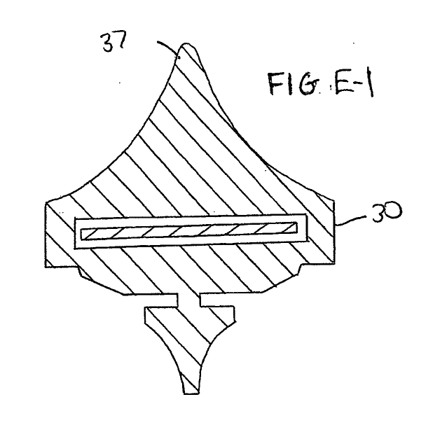

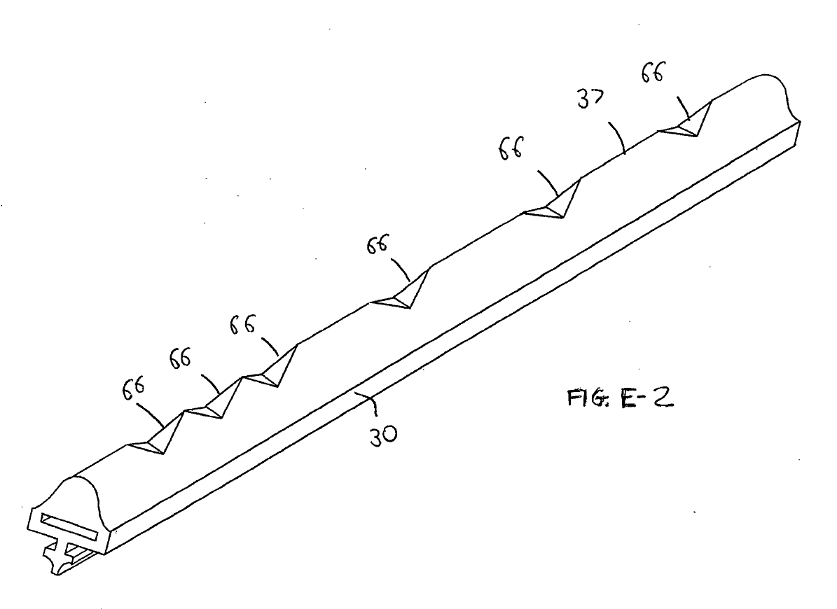

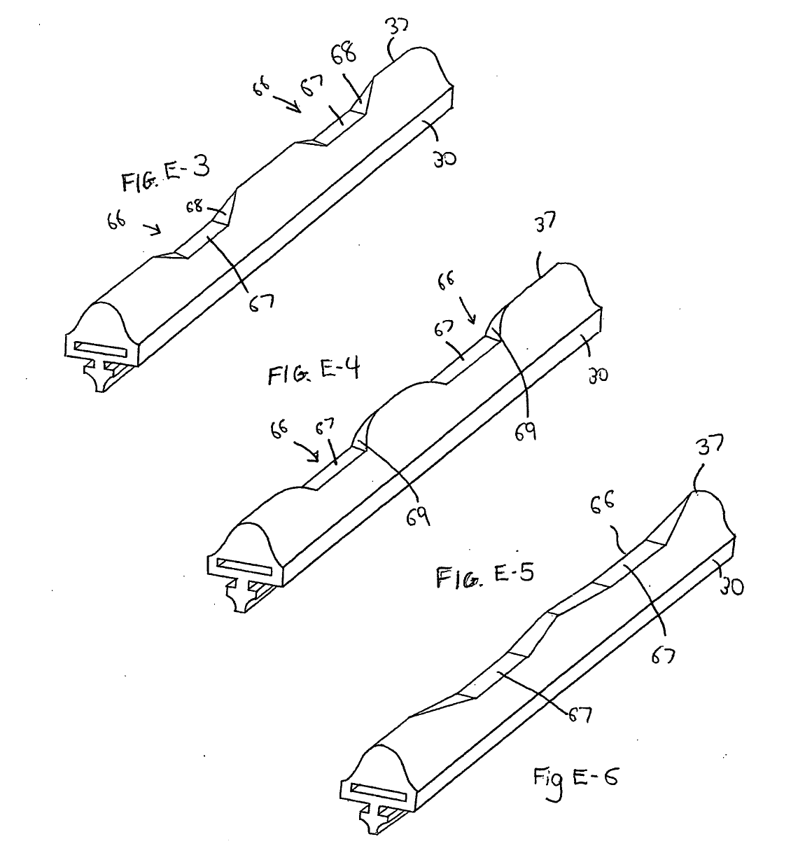

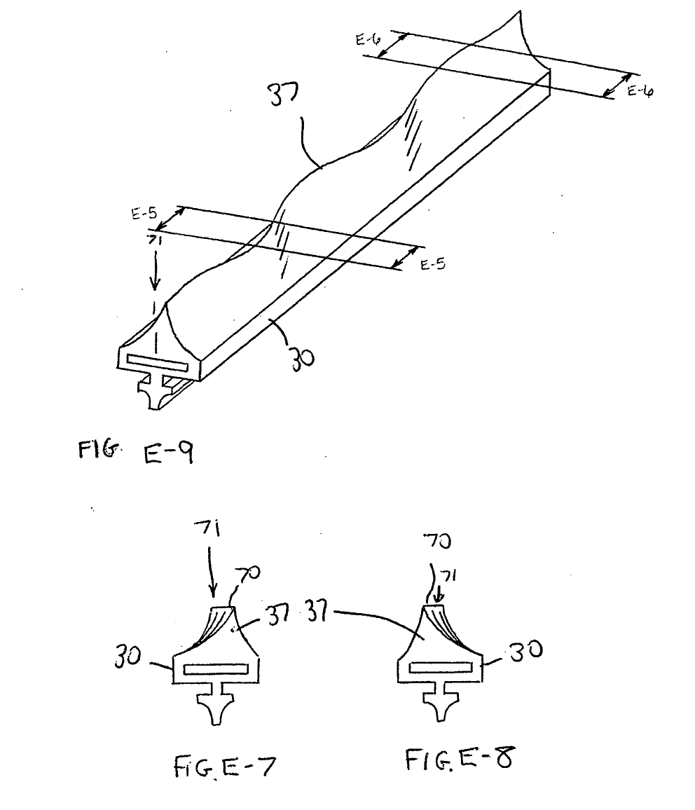

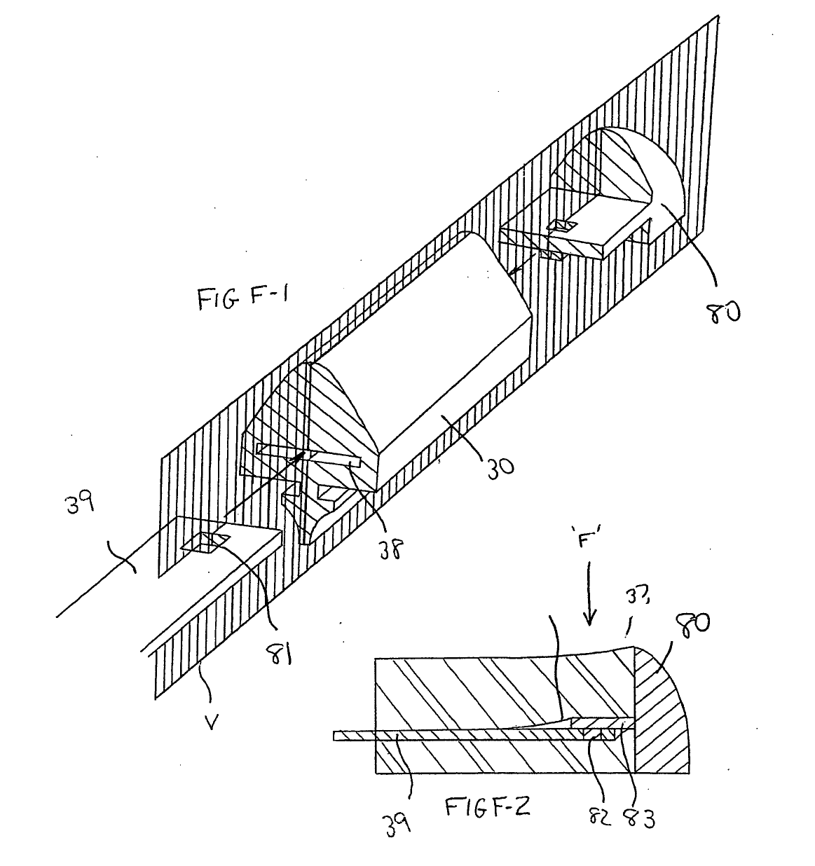

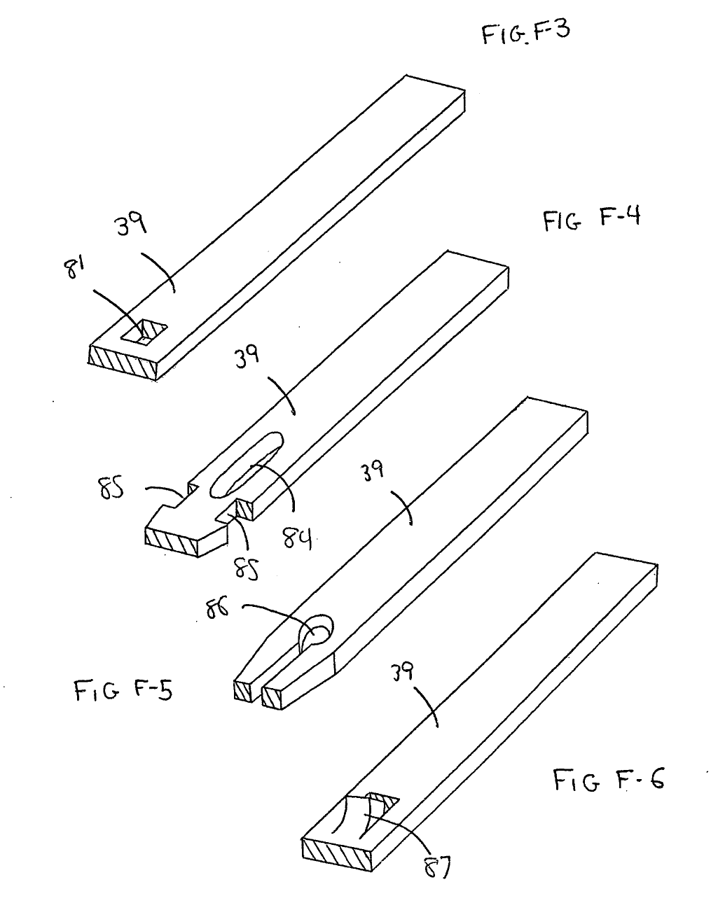

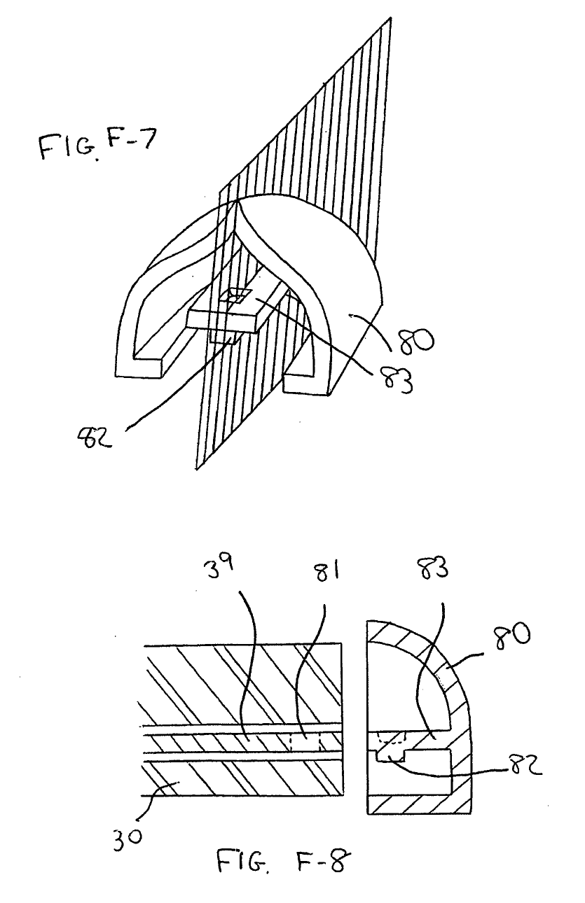

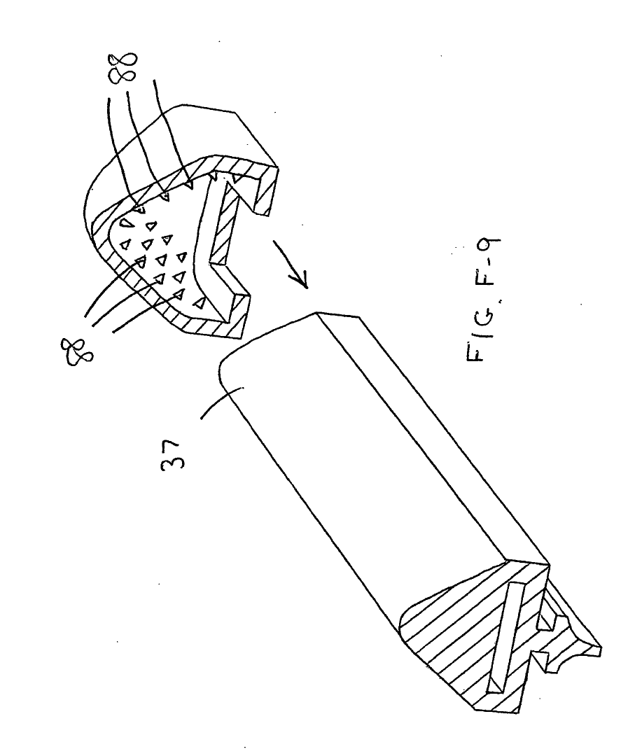

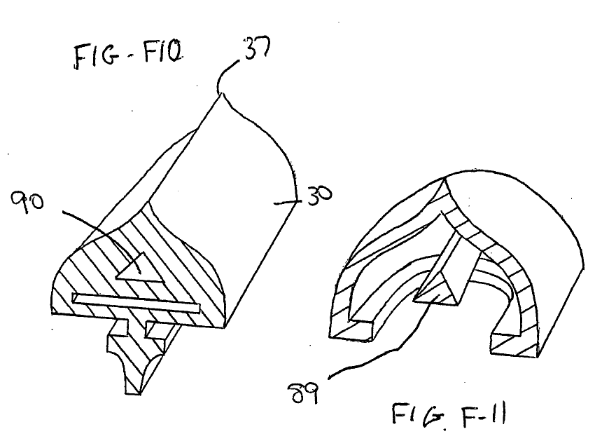

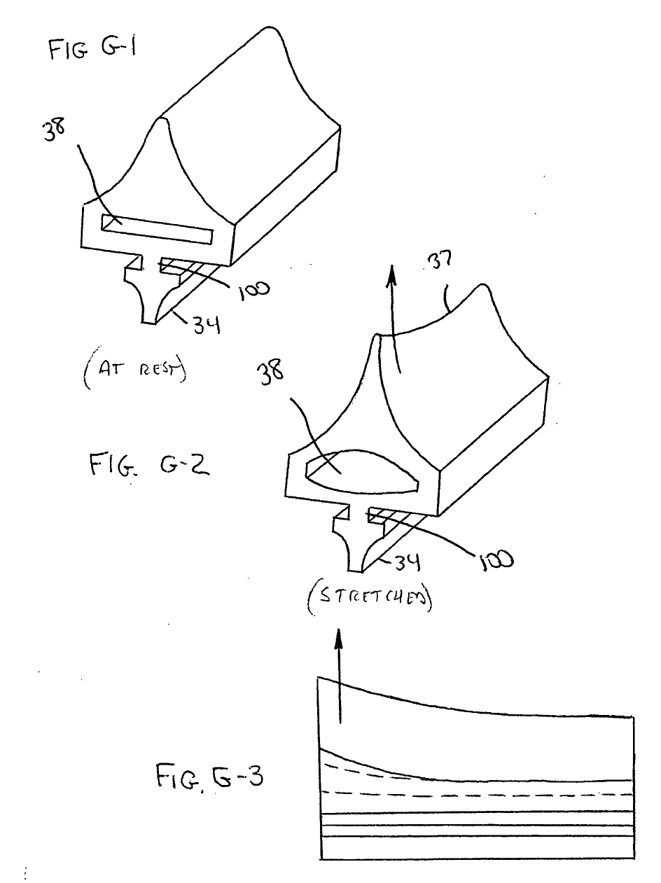

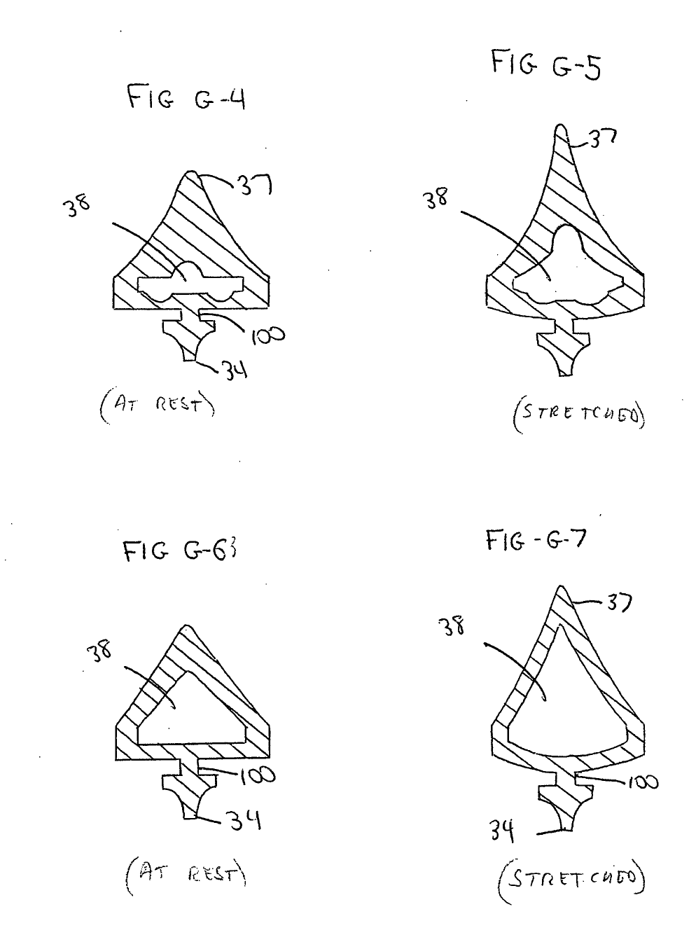

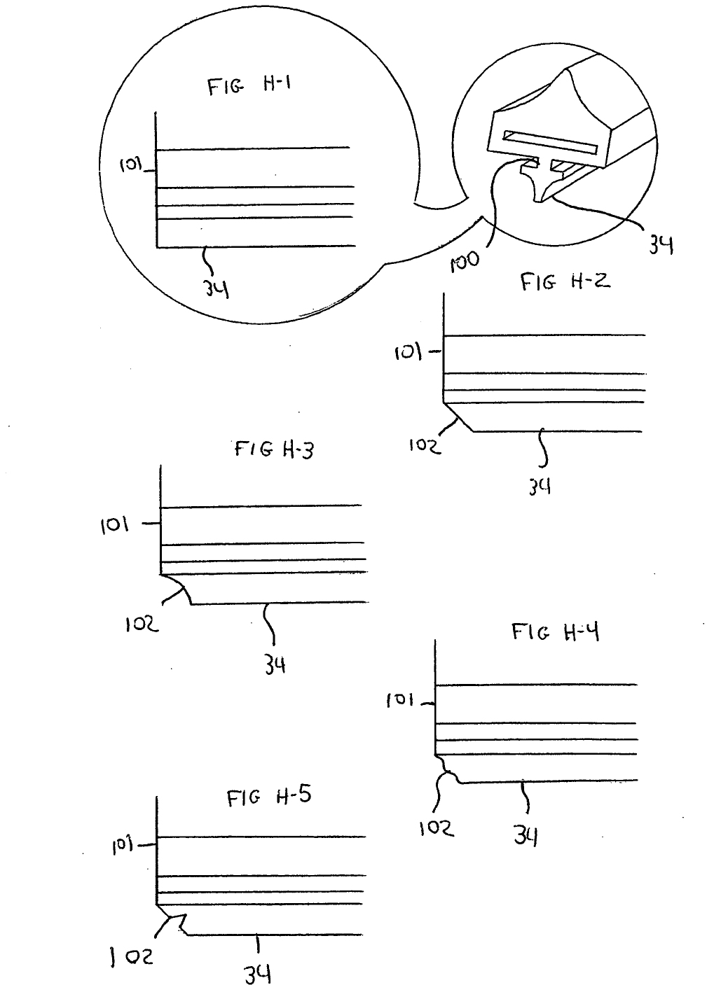

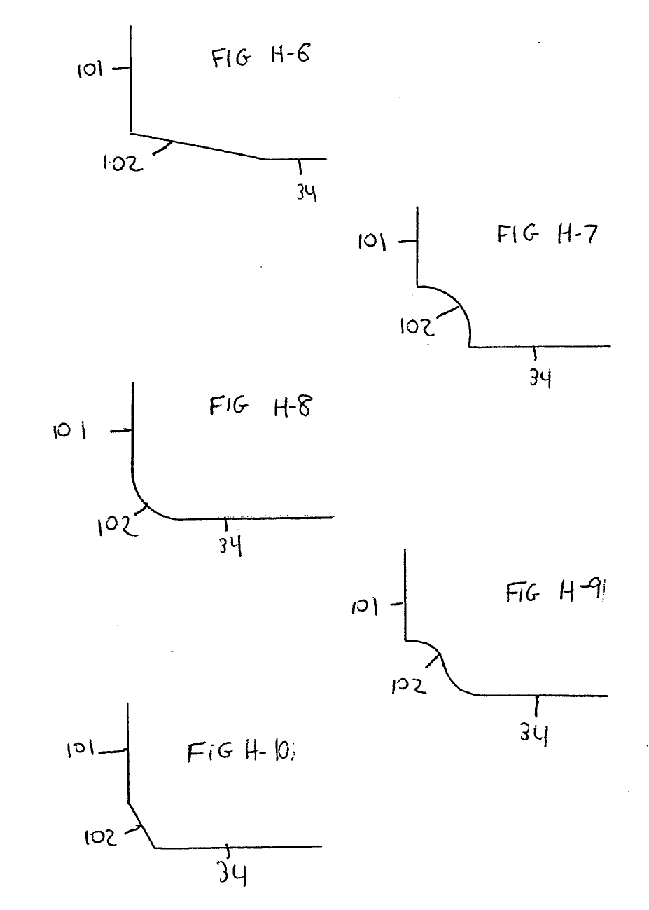

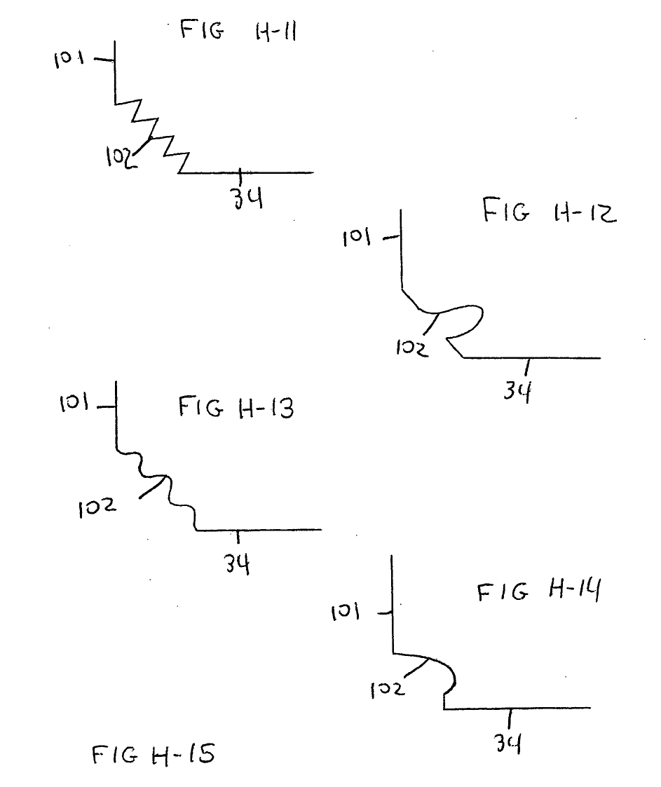

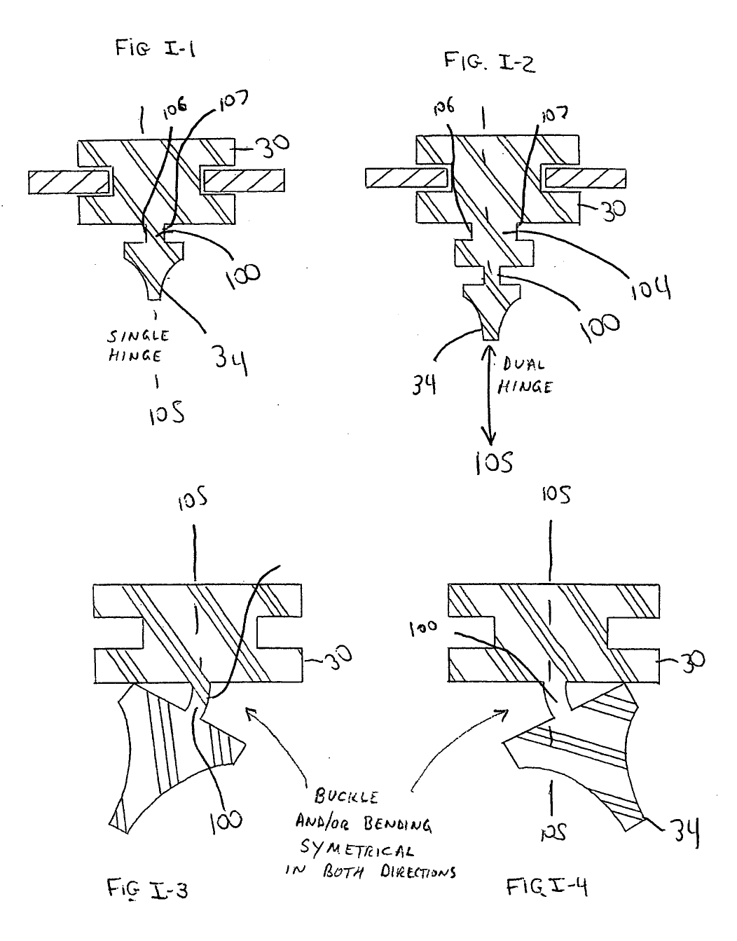

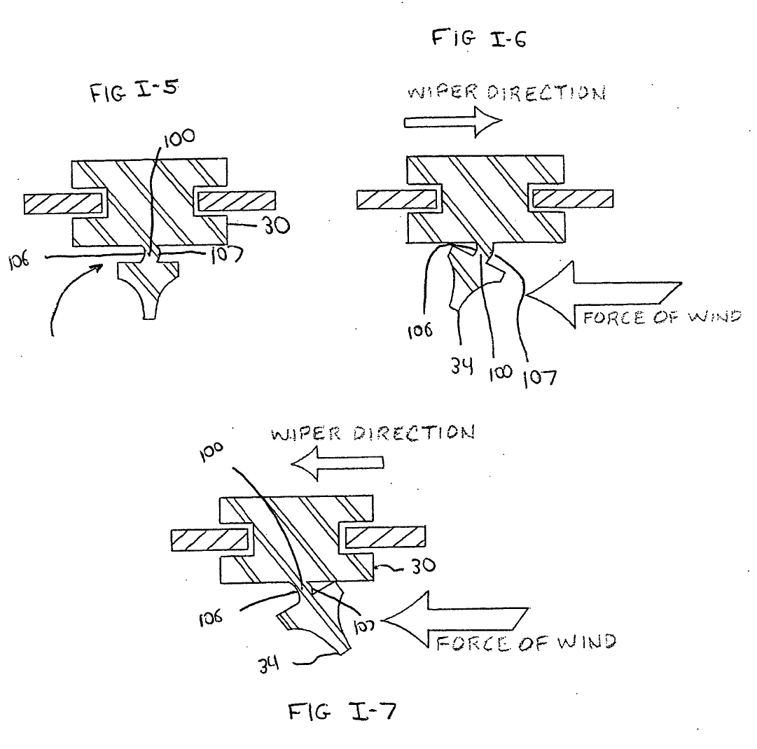

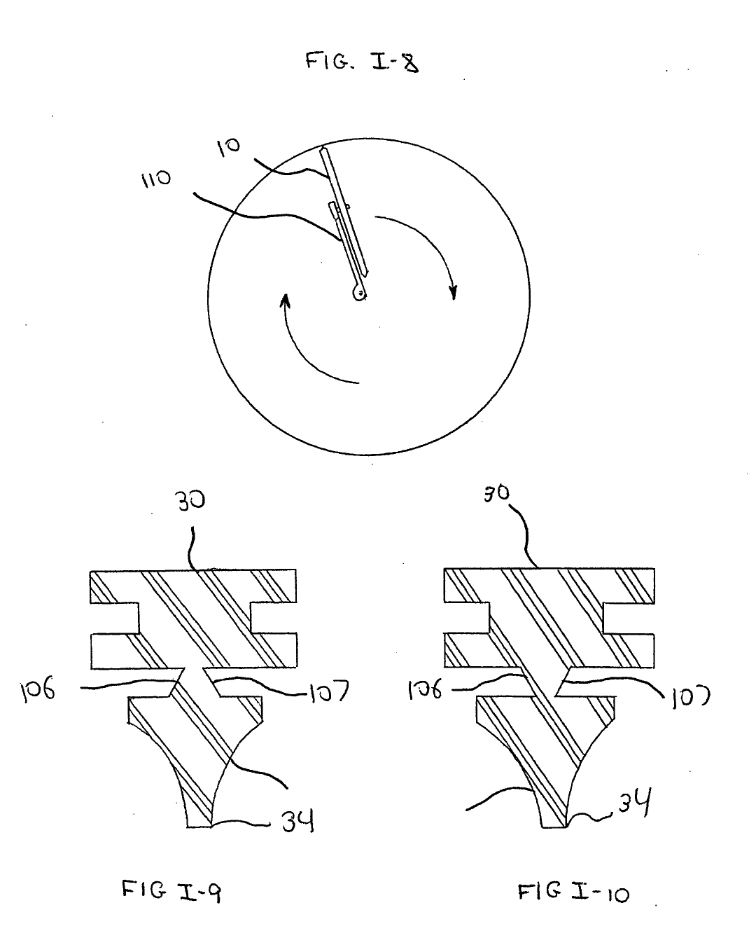

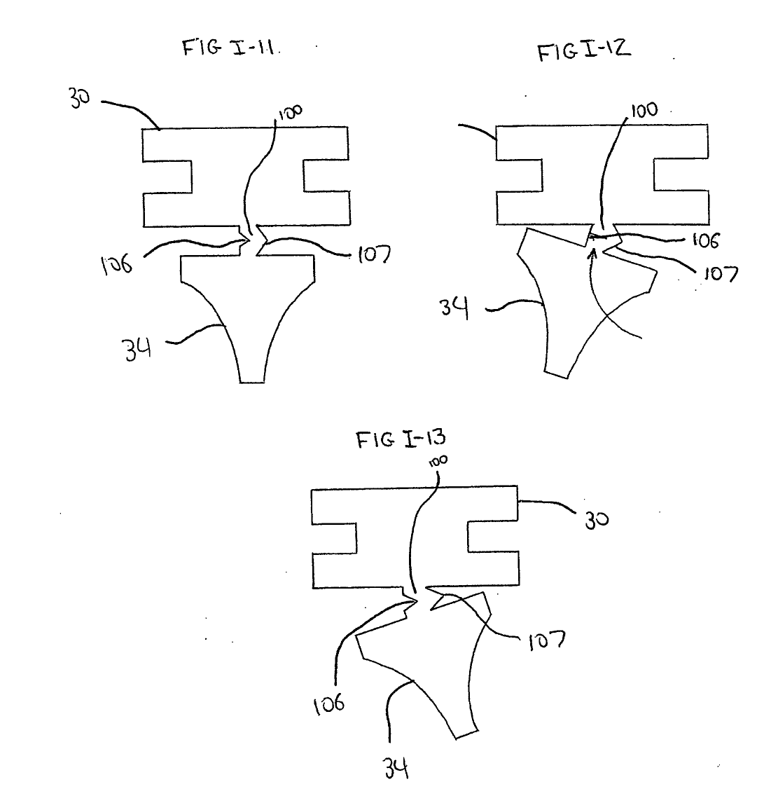

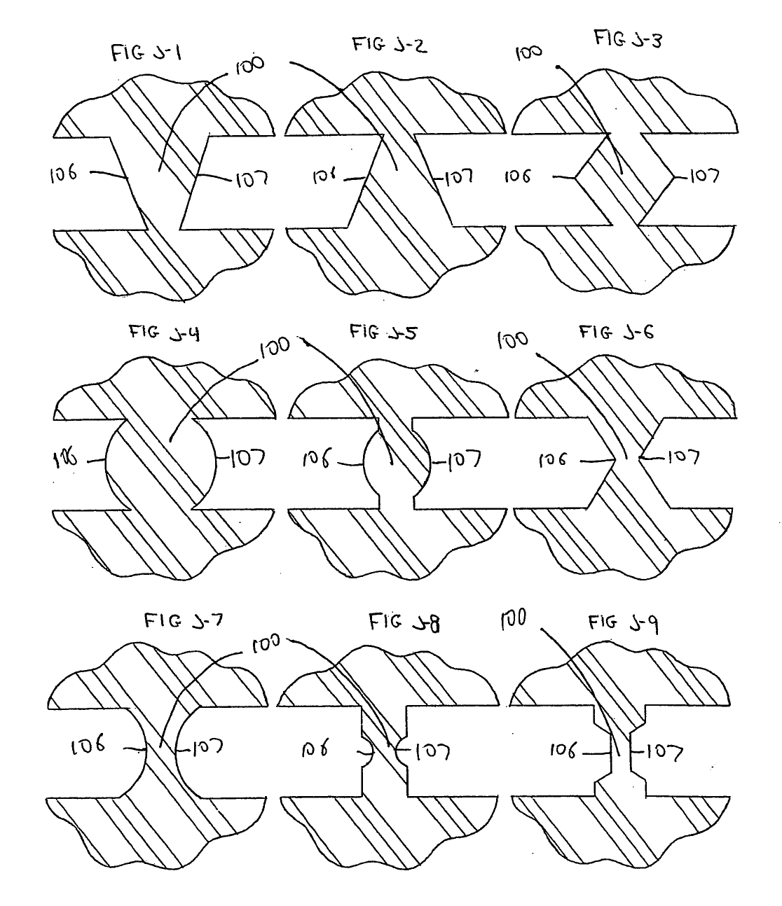

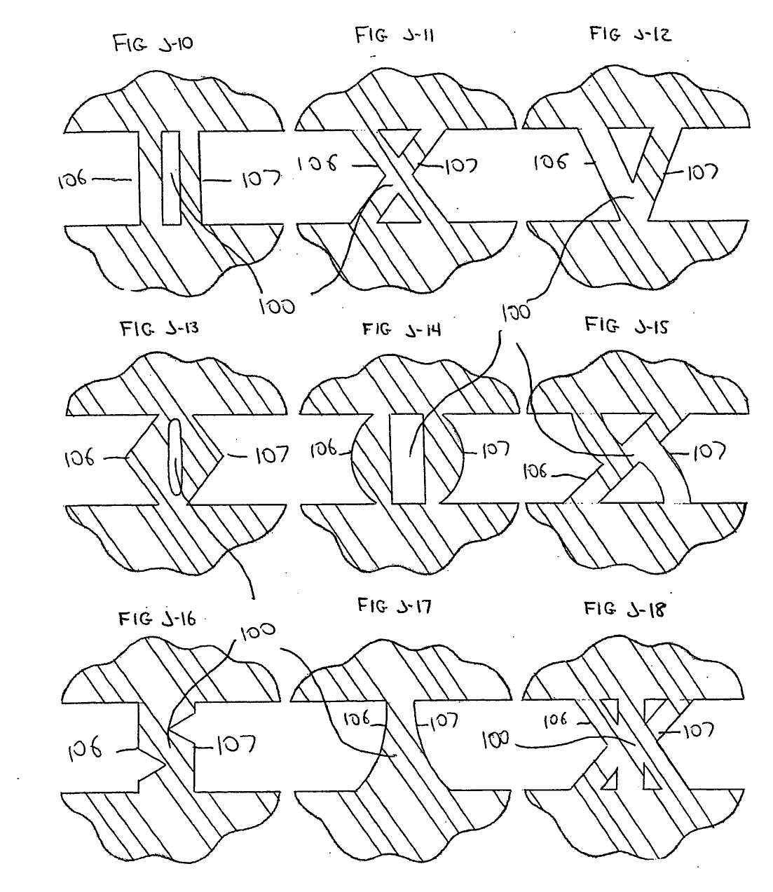

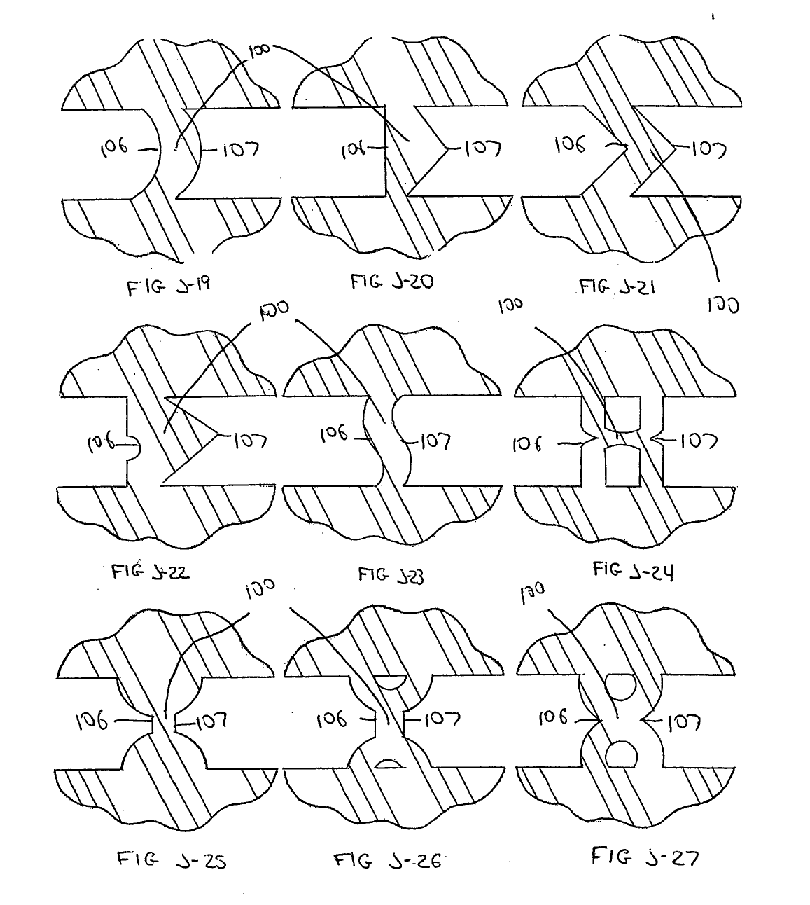

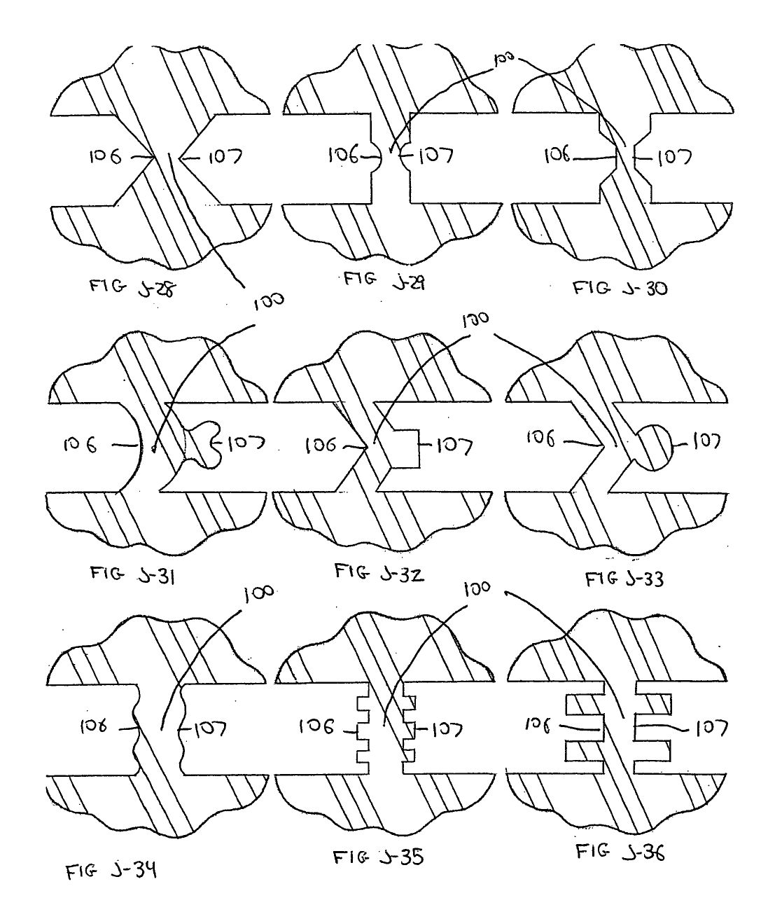

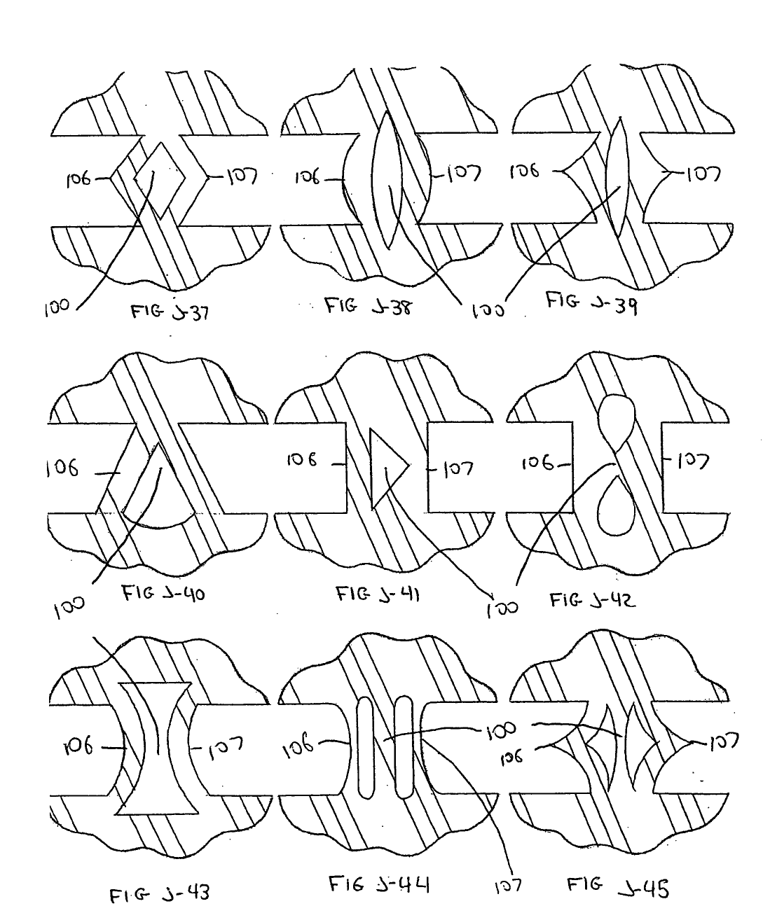

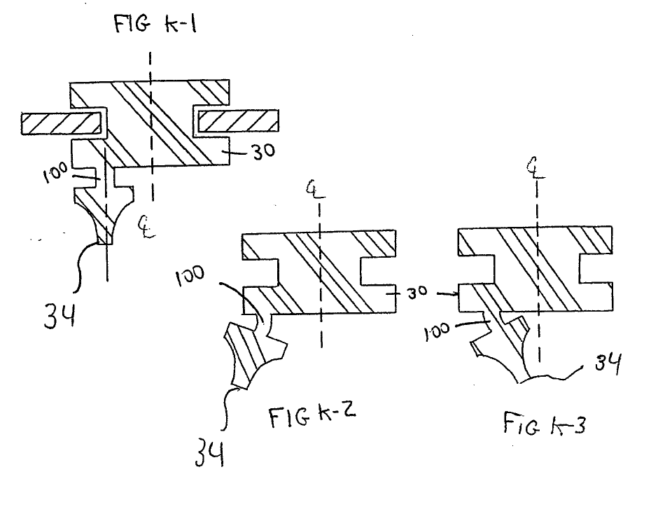

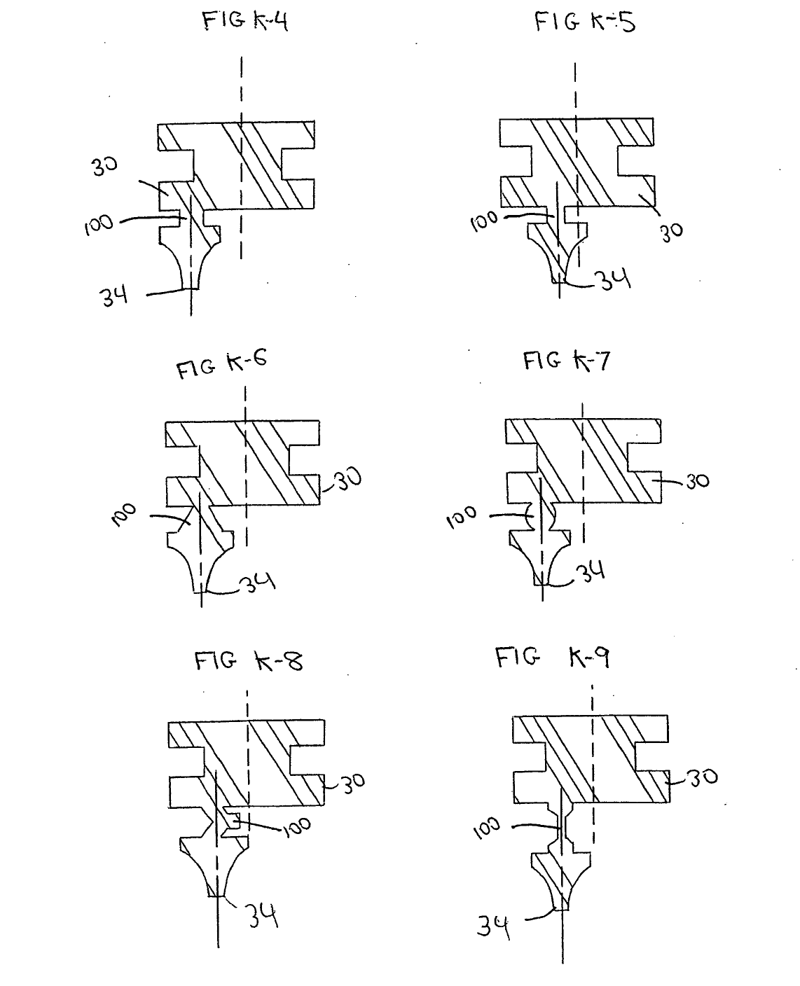

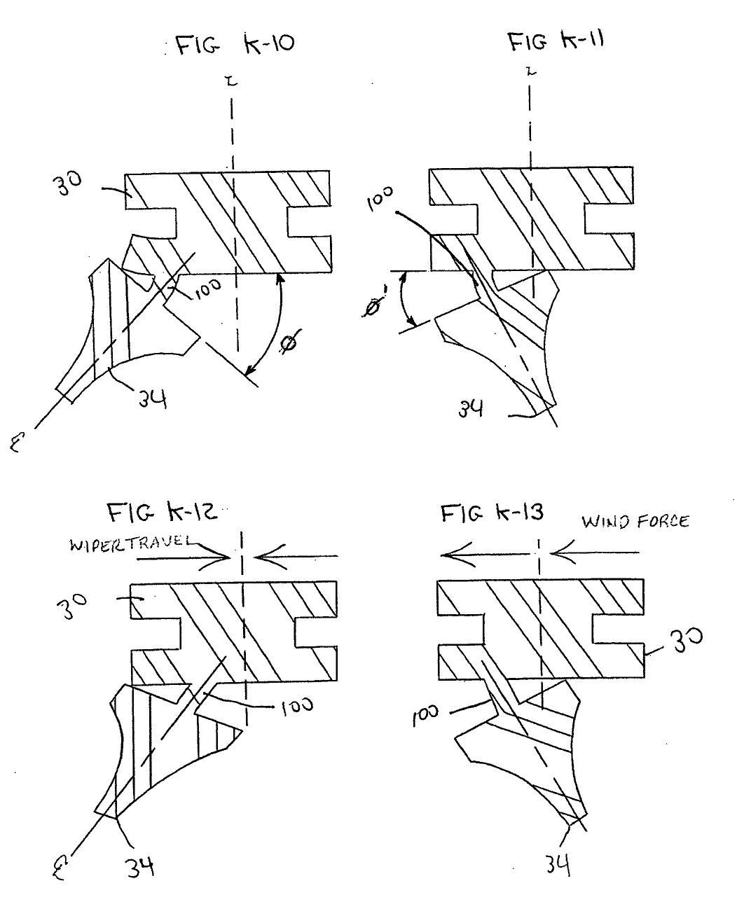

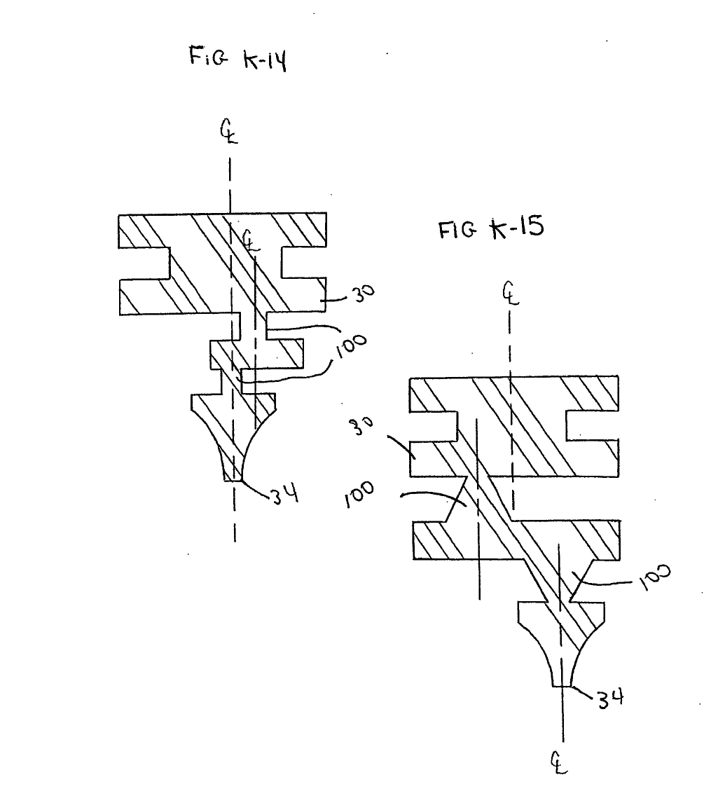

### FIELD OF THE INVENTION

The present invention relates to windshield wiper assemblies. More particularly, this invention relates to the aerodynamics of windshield wipers in affecting their longevity and performance.

### BACKGROUND OF THE INVENTION

Many wiper blade systems are designed with wind lift considerations in mind. Wind lift is the lifting of the windshield wiper off the wiping surface due to the force of wind against the wiper blade. Often, the lift is compensated for in many traditional bridge structures by designing holes and/or slots in the super structure for up-lifting forces to escape during aerodynamic applications. Other prior art forms incorporate a spoiler portion to the assembly. Most of these spoilers or air deflectors are additional assembled components. Still other systems provide little or no aerodynamic design considerations.

Current bridge systems with holes and/or slots to minimize the effects of wind lift seldom are capable of providing sufficient resistance to the demands of today's vehicle standards and requirements. Current wind-deflector systems and/or spoiler systems are not symmetrical. Side gusts and transverse winds acting on a wiper system are usually 10-20 M.P.H. and often affect wiping performance. Side gusts from large vehicles such as 18-wheel trucks often create momentary visual issues for the driver. Current systems with beam-style wipers do not provide a symmetrical wiper design for the profile of the wind-deflector portion. As a result, the wiper is subject to providing unfavorable wipe quality performance when strong side gusts are encountered. In addition, many wiper systems have one wiper blade or the other wiping in a pattern which rotates the arm past the point where the opposite side of the wiper is directly exposed to a head-wind resistance force on every cycle of normal operation.

Prior art forms do not provide additional strength to the wiper assembly, or worse, they provide an off-center strength member that introduces a twisting force on the wiper assembly which leads to poor wipe quality. Furthermore, current wiper products with wind-deflector features do not compensate for changes in the relative angle of the wiping surface relative to the head-wind forces; nor do current wiper products compensate for various curvatures of wiping surfaces. Rather, the prior art forms of wind deflectors are one-size-fits all.

### SUMMARY OF THE INVENTION

It is, therefore, an object of the present invention to provide a windshield wiper assembly having a wind-deflector element which also provides resistance of the resilient blade to twist around the supporting beam.

Another object of the present invention is to provide a symmetrical wind deflector formed with the wiper blade element, so that the assembly can be used in either direction, error proofing the installation and/or assembly process.

A further object of the present invention is to provide wiping action without incurring a reduction in wipe quality due to side gusts and/or due to head wind acting against the reverse side of the wiper during a normal stroke exceeding a 90-degree position relative to the park position.

Another object of the present invention is to provide a strength member to the wiper assembly which does not introduce off-center twist acting on the wiper assembly.

Another object of the present invention is to provide a wiper blade assembly that has definitively different wipe properties for one-wipe stroke in comparison to the other.

It is another object of the present invention to provide a wiper assembly having a focused and tunable pivot point of the associated hinge element of the wiper blade.

Lastly, it is an object of the present invention to incorporate a means of heating, or deicing the windshield wiper member, alone or in combination, with the wiping surface itself.

These and other objectives will be apparent from the following detailed descriptions of a resilient wiper blade assembly. The assembly comprises a resilient wind-deflector portion molded or extruded to provide a receiving hollow for insertion of a support beam. The resilient wind-deflector portion has a feature strategically positioned and structurally effective to prevent the resilient portion from being rotated or twisted around the support beam. The wind deflector is symmetrical with respect to the axial orientation of the support beam. The symmetry allows conversion of the wind force components from lifting forces to normal forces acting to press and/or hold the wiper against the wipe surface even when subjected to side gusts or reverse head-wind forces. The symmetry further provides a strength member acting directly over the top of the wiping lip surface, avoiding introducing a twisting force into the support beam.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. A-1 is a partial perspective assemblage view of the windshield wiper blade assembly of the present invention;

FIG. A-2 is a partial perspective view of an alternative embodiment of the present invention in a preassembled orientation;

FIG. A-3 is a partial perspective assembled view of the windshield wiper blade assembly of FIG. A-2;

FIG. A-4 is a cross-sectional end view of a further embodiment of the present invention;

FIG. A-5 is a partial perspective view of the embodiment shown in FIG. A-4;

FIG. A-6 is a cross-sectional end view of a further embodiment of the present invention;

FIG. A-7 is a partial perspective view of the embodiment shown in FIG. A-6;

FIG. A-8 is a cross-sectional end view of a further embodiment of the present invention;

FIG. AB-1 is a partial perspective assemblage view of a further embodiment of the present invention, having a sectional wind deflector;

FIGS. C-1 through C-4 are cross-sectional end views of further embodiments of the present invention;

FIGS. C-5 and C-6 illustrate cross-sectional views of the embodiments in C-3 and C-4, respectively, in use on a windshield surface;

FIGS. D-1 through D-14 illustrate partial perspective views of further embodiments of the present invention;

FIG. E-1 is a cross-sectional view of a further embodiment of the present invention;

FIG. E-2 through E-9 illustrate partial perspective views of further embodiments of the present invention;

FIG. E-10 and E-11 are cross-sectional end views of FIG. E-9 taken at lines E-5 and E-6, respectively;

FIG. F-1 illustrates a partial perspective view of a further embodiment incorporating an attachable end-effect to the wiper assembly;

FIG. F-2 is a partial cross-sectional side view of FIG. F-1 taken along plane V;

FIGS. F-3 through F-6 illustrate partial perspective views of various embodiments of the support beam;

FIG. F-7 illustrates a partial perspective view of a further embodiment of an attachable end-effect to the wiper assembly;

FIG. F-8 is a partial cross-sectional side view of the embodiment shown in FIG. F-7 in a pre-attachment position;

FIG. F-9 illustrates a partial perspective view of a further embodiment incorporating an attachable end-effect to the wiper assembly;

FIG. F-10 and F-11 show partial perspective views of a further embodiment incorporating an attachable end-effect to the wiper assembly and the receiving end of the wiper blade;

FIGS. G-1 and G-2 illustrate a partial perspective view of a further embodiment of the present invention shown in a resting state and a stretched state, respectively;

FIG. G-3 is a partial cross-sectional end view of FIG. G-2;

FIGS. G-4 and G-5 illustrate cross-sectional views of a further embodiment of the present invention shown in a resting state and a stretched state, respectively;

FIGS. G-6 and G-7 illustrate cross-sectional views of a further embodiment of the present invention shown in a resting state and a stretched state, respectively;

FIG. H-1 illustrates a close-up side view and partial perspective view of the wiper blade comprising the primary embodiment shown in FIG. A-1;

FIGS. H-2 through H-14 illustrate partial side views of alternative embodiments to the distal end of the wiper blade edge;

FIGS. I-1 and I-2 show cross-sectional end views of two alternative embodiments of the present invention;

FIGS. I-3 and I-4 illustrate cross-sectional end views of the embodiment shown in FIG. I-1 with the wiper blade pivoted in a first direction and a second direction, respectively;

FIGS. I-5 through I-7 illustrate cross-sectional views of the positioning of an alternative embodiment to the present invention with regard to wind force;

FIG. I-8 illustrates an aerial view of an alternative windshield wiping system;

FIGS. I-9 through I-13 illustrate cross-sectional views of alternative embodiments having non-parallel hinge elements;

FIGS. J-1 through J-45 illustrate partial cross-sectional close-up views of alternative embodiments for the hinge portion of the wiper blade; and

FIGS. K-1 through K-15 are cross-sectional end views of further embodiments of the windshield wiper body, having varying hinge geometries.

### DETAILED DESCRIPTION OF THE PREFERRED EMBODIMENTS

The following description of the preferred embodiments is merely exemplary in nature and is in no way intended to limit the invention, its application, or uses.

Referring now to the figures, FIG. A-1 illustrates a first embodiment of the present invention comprising a windshield wiper assembly 10 having wind deflector 37 of symmetrical geometry, a removable support beam 39 to be received within an axial-receiving throughbore 38 of the resilient wiper element 32. Wind deflector 37, which receives the force of wind when the vehicle is in motion, is symmetrical for error-proofing installation and translates the force of the wind to downward force of the wiper edge 34 to a vehicle's windshield. It further serves to provide wiping action without incurring a reduction on wipe quality due to side gusts and/or due to head winds acting against the reverse side of the wiper element 32 during a normal wiping stroke exceeding a 90-degree position relative to the park position. FIGS. A-2 and A-3 illustrate both an assembled and unassembled view, respectively, of further embodiments of the present invention wherein the wind deflector 31 is comprised of a separate resilient element that is attached by means of a tongue 33 received in a groove 35 of the wiper body 30 positioned below the passage 48 for receiving encapsulated beam 39. The desired effect of the wind deflector can be application specific, as shown in FIG. A-3 wherein wind deflector 31 comprises a thick sidewall, yielding higher-profile wiper assembly 10. Wiper body 30 can be manufactured independently of beam 39 by over-molding or co-extruding beam 39 with the resilient wiper medium.

Referring now to FIGS. A-4 and A-5, a further embodiment of encapsulated beam assembly 10 of the present invention is shown comprising elongated resilient member 12 having a body 13 and a windscreen wiping edge 14 pivotally attached to a bottom side 15 thereof by a narrow flexible neck 16. Body 13 further comprises a longitudinal passage 18 through which an elongated beam 19 of a predetermined stiffness is inserted, thereby becoming encapsulated by resilient member 12. The shape of passage 18 is generally complementary to the shape of encapsulated beam 19, thereby preventing the rotational twisting of resilient member 12 independently of encapsulated beam 19.

FIGS. A-6 and A-7 illustrate an alternative embodiment of encapsulated beam 10 of the present invention comprising a similar elongated resilient member 22 having a body 23 and a windscreen wiping edge 24 attached to a bottom side 25 thereof by a narrow flexible neck 26. The shape of the resilient member 22 and corresponding longitudinal passage 28 of this embodiment, as shown, allows a minimal predetermined amount of flexing by the elongated beam 29 contained therein, while still preventing extraneous twisting of resilient member 22 independently of and around encapsulated beam 29. FIG. A-8 shows a view of a further embodiment, similar in design to that shown in FIG. A-4, with thicker body 13 for increased wind resistance.

As an alternative to the symmetrical wind-deflector design shown in FIG. B-1, the wind deflector may be created out of sections 41, 43, 45, allowing for even greater tuning of the wind forces upon the wiper performance characteristics. A tongue 42, positioned longitudinally on a top side of the wiper body 30 and centered over the passage 38, is received in a groove 44 on the bottom surface of each wind-deflector section to securely attach each individual section. The individual segments may be removed or replaced, when worn, and may be of varying wind-deflector geometries which allow the wind forces acting on one portion of the wiper to be increased or decreased relative to the rest of the wiper.

FIGS. C-1 through C-4 illustrate the cross-section of varying designs of symmetrical wind deflector 37 shown in FIG. A-1. Each profile will have varying characteristics in the force of wind, upon which it translates to downward force of the wiper edge 24 to the vehicle windshield. FIGS. C-5 and C-6 show the effect of the wind force (indicated by arrow ‘W’) acting upon wiper profiles shown in FIGS. C-3 and C-4, respectively. The preferred profile implemented in a particular application as shown will depend upon the pitch of the vehicle windshield 5. As shown in FIGS. D-1 through E-9, the shape, geometry, and design of the wind deflector can vary from one embodiment to another. FIG. D-1 illustrates a wiper assembly having relatively tall portions 51, 52 of the wind deflector at the distal ends of the wiper assembly and a relatively short portion 50 at the mid point. FIG. D-2 illustrates a wiper assembly having a relatively wide area 55 at the mid point of the wind deflector and relatively narrow distal ends 54, 56. FIG. D-3 shows a further embodiment having a relatively sharp airfoil at the distal points 58, 59 and a blunt or more rounded wind-deflector portion 57 at the mid point of the wiper blade. The precise positioning, quantity, and orientation of these and the following features are variable to each application depending upon the subjected wind force and pitch of the windshield upon which they are implemented and are intended to remain within the scope of the present invention.

FIGS. D-4 through D-7 illustrate a series of embodiments of the present invention comprising a plurality of raised ridges 60 or depressions 61 located on wind deflector 37 in a variety of patterns perpendicular to the axis of wiper body 30. FIGS. D-8 through D-11 Illustrate a series of embodiments of the present invention comprising a plurality of raised V-shaped ridges 62 or V-shaped depressions 63 located on the wind deflector 37 in a variety of patterns perpendicular to the axis of wiper body 30.

In an alternative embodiment, as shown in FIGS. D-12 through D-14, wind deflector 37 can have a textured surface to a desired degree either uniformly light 64, heavy 65, or variably textured 64, 65, giving the wiper an increase in wind resistance per tuning requirements.

The profile of the wind deflector 37 can be varied depending on the specific application as shown in FIGS. E-1 through E-E-8. In these embodiments, wiper body 30, with wind deflector 37, may comprise a plurality of V-shaped notches 66 in the wind deflector in any number and orientation. The notches 66 may be extended as shown in FIGS. E-3 through E-5, having a flat mid section 67 and either angled sides 68, rounded sides 69, or a varying topography along the entire wind deflector 37 as illustrated in FIG. E-6. FIGS. E-7 through E-9 show a further embodiment having wind deflector 37 with a staggered centerline 70 which can alternate from being generally forward of the centerline 71 of the wiper blade to generally behind the centerline of the wiper blade, as seen in the cross-sectional views E-7 and E-8.

As disclosed above, the present invention comprising a windshield wiper assembly, has support beam 39 positioned longitudinally through wiper body 30 in throughbore 38. The present invention further comprises a plurality of end effects 80 which seal off the distal ends of the windshield wiper body so as to prevent foreign material from entering blade body 30. The means of attaching these end effects 80 is shown in the set of illustrations, FIGS. F-1 through F-11. FIGS. F-1 and F-2, as well as F-7 and F-8, show a preferred embodiment of the end effects 80 and their attachment to the wiper body. Support beam 39 comprises a square-shaped aperture 81 proximal the distal end through which a complementary tab 82 is located on the attachment flange 83 of end effect 80. End effect 80 can be of a shape which continues the profile of wind deflector 37 to round out the wipers design. It is attached by inserting attachment flange 83 into the distal end of wiper body 30 so as to overlap the distal end of support beam 39 within throughbore 38. The resilience of the wiper body allows the through bore 38 to stretch to accommodate the overlapping at the end of the blade, and the resilient force ‘F’ retains tab 82 within aperture 81, securing the end effect. End effect 80 can be designed to be flush with the distal end of wiper body 30, as shown in FIG. F-2, or can be designed to encapsulate the end, as shown in FIGS. F-7 and F-8.

The ends of support beam 39 can have a variety of attachment means for connecting to end effect 80, as shown in FIGS. F-3 through F-6. Besides the tab-receiving aperture 81, other possibilities include a pair of lateral notches 85 with a central aperture 84, a key hole slot 86, or a deflected locking tab 87, which intimately communicate with the end effect.

FIG. F-9 shows a further embodiment of an encapsulating end effect 80, comprising a plurality of rearward projecting teeth 88 which impinge upon the resilient surface of wind deflector 37 as it is press fitted over the end of the wiper. Alternatively, FIGS. F-10 and F-11 show an embodiment which utilizes a triangular (or other shape) tab 89 received in a complementary aperture 90 located in wiper body 30, separate from throughbore 38 in which support beam 39 is located. Aperture 90 is sized appropriately to frictionally hold tab 89 as end effect 80 is positioned over the end of wiper body 30 and wind deflector 37.

Referring now to FIGS. G-1 through G-7, the present invention provides a further advantage in the event of the wiper blade edge 34 becoming stuck or frozen to a windshield. In an effort to prevent the tearing of blade edge 34 at the hinge 100 from the wiper system trying to force the wiper into normal cycles while frozen, the throughbore 38 provides a stress relief point preventing hinge 100 from being subject to excessive tensile forces which would normally result tears or rips. The aperture which normally encapsulates the support beam disclosed herein can comprise a plurality of shapes in cross section, as shown in FIGS. G-4 through G-7, in both their resting state and their stretched state. Alternatively, as shown in FIGS. H-1 through H-14, blade edge 34 can be beveled at the distal ends 101 to relieve tensile stress applied against the hinge to prevent it from being ripped or torn due to normal conditions of sticking or freezing to the wiping surface. The bevel 102, which is molded or formed as a function of a cutting process after the blade is molded, can take on the geometry of a radius, in convex or concave, scalloped, or notched, as shown in the above figures.

In a further embodiment, the longitudinal passage or throughbore 28 may further provide a communication means for the transmission and distribution of washing fluid. The passage could further be used as a portion of a recirculation system of ‘heated’ fluid, possibly a branch off the radiator coolant fluid being pumped therethrough, to warm the wiper and subsequently melt a frozen condition of the wiper to a frozen windshield. Further means could be implemented through the bore 28, as well, such as an embedded heater of electric, solar, or thermal air conduits for the purposes of providing a thawing heat source for wiper edge 34 to guard against frozen conditions.

Referring now to hinge 100 of the present invention, its design implementation and position in relation to the windshield wiper assembly can impact the longevity and performance of the blade assembly in connection with a wind deflector 37. Referring now to FIGS. I-1 through I-4, windshield wiper body 30 and wiping blade edge 34 is shown, connected with the hinge portion, generally numbered 100. Hinge 100 can be a single element as shown in FIG. I-1 or can be compound hinges comprising dual pivot points 100, 104 as shown in FIG. I-2. The side surfaces of the hinge 106 and 107 are parallel and symmetrical, which allows the hinge to buckle or bend symmetrically about the central axis 105 as the wiper flips back and forth, as shown in FIGS. I-3 and I-4. Often, it may be desirous to have asymmetrical hinge movement specialized applications, as shown in FIGS. I-5 though I-13. For example, a wiper blade designed to behave in one manner with response to the wind force may have a second behavioral attribute in response to motion with the wind force. Others may include wipers designed for applications that only travel continuously in one direction with the wiper arm 110 and blade assembly 10 shown in FIG. I-8. Other applications may include a wiper which wipes with its edge contacting the surface in one direction, but is lifted during the return oscillation. Additionally, hinge 100 having parallel sides 106, 107 lacks a focused hinge point and controlled pivot point during the flipping action of the wiper from one direction to the other. FIGS. I-5 through I-7 illustrate one embodiment of the invention where sides 106, 107 of hinge portion 100 of the wiper blade are curved in the same direction, shown at rest (FIG. I-5), traveling against the force of wind (FIG. I-6), and traveling with the force of wind (FIG. I-7)

Hinge portion 100 can be formed of a plurality of elements having non parallel sides 106 and 107 that yield varied profiles as shown in FIGS. J-1 through J-45. An advantage of these designs is that hinge 100 can be focused to buckle or pivot at any point along the axis of the hinge. Furthermore, the asymmetry of hinge 100 will allow it to rotate and/or buckle a certain amount in one direction, while limiting rotation or pivoting of the hinge in the opposite oscillation.

In a further embodiment, the hinge may be positioned asymmetrically off the centerline (C_{L}) of the wiper blade, best shown in FIGS. K-1 through K-15. Hinge 100 can be formed similar to any of the above embodiments having parallel sides, non parallel sides, asymmetrical sides, compound hinges, or any combination thereof. The advantages of this embodiment and its variations thereof can best be shown in FIGS. K-10 through K-13 wherein the specific wiper action in one direction of travel is significantly and deliberately different from the wiping action in the opposite direction by comparing the angle Θ with the return angle Θ′. This provides the opportunity to have a wiper that behaves in one way against a specified force, such as the wind, while allowing the wiper to have different wiping characteristics in the opposite direction, such as with the wind force.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A windshield wiper blade assembly utilized in combination with a plurality of pitched vehicular windscreens comprising:
a resilient wiping element, said wiping element comprising a windscreen surface wiping edge and a longitudinal passage therethrough;
a semi-rigid, encapsulated beam member, said beam member positioned within said longitudinal passage of said wiping element;
a windshield wiper connector element, said connector element detachably attaching said wiper blade assembly to at least one type of windshield wiper arm attached to a motor vehicle;
an airfoil wind-deflector element, said wind-deflector element utilizing the force of wind during forward movement of the vehicle to provide downward pressure of said resilient wiping element against a windscreen of said motor vehicle, said wind-deflector element further utilizing the force of wind during forward movement of the vehicle to prevent rotational twisting of said resilient wiping element around said encapsulated beam member.

2. The windshield wiper blade assembly of claim 1, wherein said airfoil wind-deflector element is incorporated into said resilient wiping element.

3. The windshield wiper blade assembly of claim 2, wherein said airfoil wind-deflector element comprises a raised symmetrical ridge running longitudinally along the top side of said resilient member.

4. The windshield wiper blade assembly of claim 2, wherein said airfoil wind-deflector element comprises a raised rounded symmetrical ridge running longitudinally along the top side of said resilient member.

5. The windshield wiper blade assembly of claim 2, wherein said airfoil wind-deflector element comprises a raised parabolic symmetrical ridge running longitudinally along the top side of said resilient member.

6. The windshield wiper blade assembly of claim 2, wherein said airfoil wind-deflector element comprises a raised pointed symmetrical ridge having a leading face and trailing face of equal size and angle running longitudinally along the top side of said resilient member.

7. The windshield wiper blade assembly of claim 2, wherein said airfoil wind-deflector element comprises a raised ridge having a vertical relief comprising an alternating relatively high and low apex running longitudinally along the top side of said resilient member.

8. The windshield wiper blade assembly of claim 2, wherein said airfoil wind-deflector element comprises a raised ridge having a vertical relief comprising relatively high and sharp apexes at the distal ends of said deflector, transitioning into a relatively low relief apex in the center portion of said resilient member.

9. The windshield wiper blade assembly of claim 2, wherein said airfoil wind-deflector element comprises a laterally wider midpoint than the distal ends of said resilient member.

10. The windshield wiper blade assembly of claim 2, wherein said airfoil wind-deflector element comprises a plurality of raised ridges positioned along the length of said wind deflector perpendicular to the direction of travel of said wiper blade assembly.

11. The windshield wiper blade assembly of claim 2, wherein said airfoil wind-deflector element comprises a plurality of depressions positioned along the length of said wind deflector perpendicular to the direction of travel of said wiper blade assembly.

12. The windshield wiper blade assembly of claim 10, wherein said airfoil wind-deflector element further comprises a plurality of depressions positioned along the length of said wind deflector perpendicular to the direction of travel of said wiper blade assembly.

13. The windshield wiper blade assembly of claim 10, wherein said plurality of raised ridges are angled off center from perpendicular to the direction of travel of said wiper blade assembly.

14. The windshield wiper blade assembly of claim 11, wherein said plurality of depressions are angled off center from perpendicular to the direction of travel of said wiper blade assembly.

15. The windshield wiper blade assembly of claim 12, wherein said plurality of raised ridges and said plurality of depressions are angled off center from perpendicular to the direction of travel of said wiper blade assembly.

16. The windshield wiper blade assembly of claim 2, wherein said airfoil wind-deflector element comprises a textured surface.

17. The windshield wiper blade assembly of claim 16, wherein said texture alternates along the length of said wind deflector between areas of heavy and light texturing.

18. The windshield wiper blade assembly of claim 2, wherein said airfoil wind-deflector element comprises a plurality of detents along the apex of said wind deflector.

19. The windshield wiper blade assembly of claim 2, wherein said airfoil wind-deflector element alternates with a gentle transition between a position forward of the centerline of said resilient member and a position rearward of the centerline of said resilient member.

20. The windshield wiper blade assembly of claim 2, further comprising end caps at one or more terminal ends, said end caps comprising a flange with locking tab extending partially into the distal ends of said longitudinal passage, and engaging with an aperture through the distal end of said encapsulated beam member and held in position by the biasing force of the walls of said longitudinal passage.

21. The windshield wiper blade assembly of claim 2, further comprising end caps at one or more terminal ends, said end caps comprising a receiving aperture, which receives the distal ends of said encapsulated beam member, said terminal end of said beam member having a means of frictionally retaining said end cap on said distal end of said beam member.

22. The windshield wiper blade assembly of claim 2, further comprising end caps at one or more terminal ends, said end caps comprising a receiving aperture, which receives the distal ends of said encapsulated beam member, said end cap having a means of frictionally retaining the terminal end of said encapsulated beam member therewithin.

23. The windshield wiper blade assembly of claim 1, wherein said airfoil wind-deflector element is a separate element attached by an attachment means to the top side of said resilient wiping element.

24. The windshield wiper blade assembly of claim 23, wherein said attachment means of said airfoil wind-deflector element comprises a longitudinally running tongue and groove.

25. The windshield wiper blade assembly of claim 24, wherein said wind-deflector element comprises a plurality of sections aligned along the top side of said resilient member.

26. A windshield wiper blade assembly comprising:
a resilient wiping element, said wiping element comprising a longitudinal passage running longitudinally therethrough, said passage having a generally diamond-shaped cross-section wherein said lateral corners are pinched in;
a semi-rigid, encapsulated beam member, said beam member positioned within said longitudinal passage of said wiping element parallel to the wiping edge of said wiping member;
a windshield wiper connector element, said connector element detachably attaching said wiper blade assembly to at least one type of windshield wiper arm attached to a motor vehicle.

27. The windshield wiper blade assembly of claim 2, further comprising a bevel on the distal ends of said windscreen surface wiping edge, said bevel comprising one of the following shapes: straight bevel, curved bevel, notched bevel, rounded bevel, concave bevel, and/or oscillating bevel.

28. The windshield wiper blade assembly of claim 2, further comprising a hinged portion molded between said windscreen surface wiping edge and said longitudinal passage.

29. The windshield wiper blade assembly of claim 28, further comprising dual hinge portions aligned vertically between said windscreen surface wiping edge and said longitudinal passage.

30. The windshield wiper blade assembly of claim 28, wherein said hinge portion is curved.

31. The windshield wiper blade assembly of claim 28, wherein said hinge portion is upwardly diverging.

32. The windshield wiper blade assembly of claim 28, wherein said hinge portion is downwardly diverging.

33. The windshield wiper blade assembly of claim 28, further comprising dual hinge portions, aligned horizontally between said windscreen surface wiping edge and said longitudinal passage.

34. The windshield wiper blade assembly of claim 28, wherein said hinge portion is rearwardly offset from the centerline of the resilient member.

35. The windshield wiper blade assembly of claim 28, wherein said hinge portion is forwardly offset from the centerline of the resilient member.

36. The windshield wiper blade assembly of claim 31, wherein said hinge portion is rearwardly offset from the centerline of the resilient member.

37. The windshield wiper blade assembly of claim 32, wherein said hinge portion is rearwardly offset from the centerline of the resilient member.

38. The windshield wiper blade assembly of claim 29, wherein said dual hinges are offset vertically from each other.
